(19) United States
(12) Patent Application Publication
(10) Pub. No.: US 2005/0062661 A1
(43) Pub. Date: Mar. 24, 2005

(54) Dual circular polarization flat plate antenna that uses multilayer structure with meander line polarizer

(76) Inventors: Amir I Zagiiloul, Bethesda, MD (US); Eric Christopher Kohls, Washington, DC (US); Liang Q. Sun, Vienna, VA (US)

Correspondence Address: SUGHRUE MION, PLLC, 2100 PENNSYLVANIA AVENUE, N.W., SUITE 800, WASHINGTON, DC, 20037, US

(21) Appl. No.: 10/474,816

(22) PCT Filed: Apr. 15, 2002
(86) PCT No.: PCT/US02/08263

Related U.S. Application Data
(60) Provisional application No. 60/283,916, filed on Apr. 13, 2001.
(60) Provisional application No. 60/283,917, filed on Apr. 13, 2001.

(51) Int. Cl. H01Q 19/00

(52) U.S. Cl. 343/756

(57) ABSTRACT

An apparatus performs dual circular polarization in a flat plate antenna simultaneously, and does not require more than two meander line polarization layers. A first linear polarization layer and a second linear polarization layer including a polarization power divider (2, 4) and a radiation panel (3, 5) positioned on the polarization power divider (2, 4), are provided to respectively perform first and second senses of linear polarization. Additionally, a first meander line polarizer layer (6) is positioned on the second linear polarization layer and a second meander line polarizer layer (7) is positioned on the first meander line polarizer layer. The first and second meander line polarizer layers (6, 7) convert linear polarization signals into a circular polarization signals.

This application claims the benefit of U.S. Provisional Application Nos. 60/283,916 and 60/283,917, filed Apr. 13, 2001, under 35 U.S.C. § 119(e).

### BACKGROUND OF THE INVENTION

1. Field of the Invention

The present invention disclosure relates to a low-cost flat plate antenna for direct broadcasting systems (DBS) and other low cost applications, and more specifically, a two-layer meander-line polarizer is used to simultaneously produce two senses (i.e., components) of orthogonal circular polarizations.

2. Background of the Invention

In the related art, two orthogonal senses of linear polarization in a multilayer printed circuit structure can be produced, as well as a single circular polarization using a multilayer printed circuit structure. The related art single circular polarization implementation includes a special radiating element with perturbation segments and a single point feeding or a linear polarization antenna with at least 3 to 4 layers of a meander line polarizer.

However, the related art does not disclose or suggest use of dual linear polarization antenna with a meander line polarizer. More specifically, the use of two meander line layers to convert the linear polarization into a circular polarization for a single or dual senses of circular polarization has not been demonstrated as achievable in the related art. Thus, the aforementioned related art structure has at least the disadvantage of requiring extra layers in the printed circuit antenna, which results in an increased cost, if production of an output having two orthogonal senses is desired.

### SUMMARY OF THE INVENTION

It is an object of the present invention to overcome at least the aforementioned problems and disadvantages of the related art system.

It is another object of the present invention to minimize a number of layers present in a multilayer structure of a flat plate antenna, thus minimizing cost and size of the flat plate antenna.

To achieve at least the above objects, an apparatus for performing dual circular polarization in a flat plate antenna is provided, comprising a linear polarizer configured to perform a first sense and a second sense of a linear polarization, and generate linear polarization outputs, and a meander line polarizer positioned on the linear polarization structure and having a first layer stacked on a second layer. In this apparatus, the meander line polarizer generates circular polarization signals based on the linear polarization outputs.

Additionally, a method of performing dual circular polarization is provided, comprising the steps of (a) performing a first sense of linear polarization to generate a first linearized output, and (b) performing a second sense of linear polarization to generate a second linearized output The method further comprises the step of (c) receiving the first linearized output and the second linearized output in a two-layer meander line polarizer to generate circular polarization signals.

Further, a flat plate antenna configured to perform dual circular polarization is provided, comprising an apparatus for performing dual circular polarization. The apparatus includes a first linear polarization layer configured to perform a first sense of a linear polarization, a second linear polarization layer, positioned on the first linear polarization layer, configured to perform a second sense of the linear polarization, a first meander line polarizer layer positioned on the second linear polarization layer, and a second meander line polarizer layer positioned on the first meander line polarizer layer. The first meander line polarizer layer and the second meander line polarizer layer convert linear polarization signal outputs from the first linear polarization layer and the second linear polarization layer into circular polarization signals.

### BRIEF DESCRIPTION OF THE DRAWINGS

The accompanying drawings, which are included to provide a further understanding of illustrative, nonlimiting embodiments of the present invention and are incorporated in and constitute a part of this specification, illustrate embodiments of the invention and together with the description serve to explain the principles of the present invention.

FIG. 1 illustrates a multilayer structure of a dual circular polarizer flat plate antenna according to an exemplary embodiment of the present invention;

FIG. 2 illustrates a configuration of the meander line polarizer layers according to the exemplary embodiment of the present invention;

FIG. 3 illustrates a graphical representation of a measured axial ratio of the meander line polarizer over 500 MHz bandwidth according to the present invention; and

FIG. 4 illustrates a graphical representation of a measured axial ratio of the meander line polarizer over 2 GHz bandwidth according to the present invention.

### DETAILED DESCRIPTION OF ILLUSTRATIVE EMBODIMENTS OF THE INVENTION

Reference will now be made in detail to an illustrative, non-limiting embodiment of the present invention, examples of which are illustrated in the accompanying drawings. In the present invention, the terms are meant to have the definition provided in the specification, and are otherwise not limited by the specification.

The present invention includes a low-cost flat plate antenna that uses a two-layer meander-line polarizer to simultaneously produce two senses of orthogonal circular polarizations. The multiple-layer printed-circuit antenna includes a first set and a second set of linear polarization layers stacked on one another. The respective outputs of the first and second sets of the linear polarizer layers are the respective orthogonal linear polarizations. Additionally, a first and second meander-line polarizer layer are stacked together, on the top of the stacked (i.e., dual) linear polarization layers. The meander line polarizer layers introduce the phase shifts and signal decomposition, which leads to two sets of orthogonal linear polarizations at phase quadratures to produce two senses of orthogonal circular polarizations. The arrangement of the above-disclosed layers is described in greater detail below with respect to the drawings.

As a result, low axial ratios (e.g., approximately 1 to 2 dB) can be obtained over antenna beam width and over a wide frequency band (e.g., greater than about 20%). Also, the minimization of the number of printed circuit layers by having only two meander line polarizer layers results in the reduction of production cost of the antenna.

The printed circuit layers of the exemplary embodiment of the present invention are used as the feed lines, radiating elements and polarizer for the antenna device. Also, the two-layer meander line polarizer converts the array dual linear polarization into dual circular polarization. The design of the array and the two-layer polarizer can also be scaled to different frequency bands.

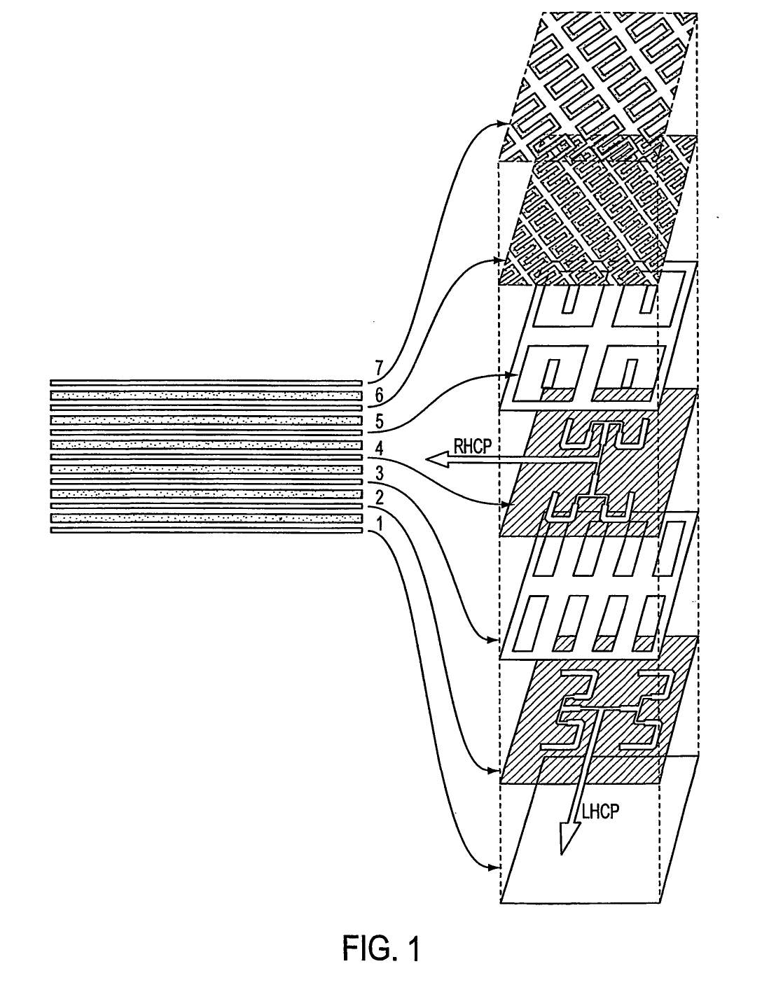

FIG. 1 shows the multilayer structure of the flat plate antenna that simultaneously produces dual circular polarizations, according to an exemplary embodiment of the present invention. A bottom layer that is a ground plane 1 is provided. Further, four printed circuit layers 2, 3, 4, 5 are stacked above the ground plane as feeding lines and radiating elements for the two orthogonal linear polarizations (i.e., linear polarization A and B). For example, but not by way of limitation, a first power dividing network 2 (i.e., power divider) and a first radiation panel 3 are disclosed for polarization network A, and a second power dividing network 4 and a second radiation panel 5 are disclosed for polarization network B.

As further illustrated in FIG. 1, two printed circuit layers 6, 7 are first and second layers of the meander line polarizer, which convert the linear polarization signals into circularly polarized signals (i.e., circular polarization A and B), and are stacked on top of the stacked printed circuit layers 2, 3, 4, 5. In the present invention, low-loss foam layers (e.g., 8) separate the printed circuit layers from one other. Thus, the two senses of linear polarization pass through the two-layer meander line polarizer independently to simultaneously produce two orthogonal senses of circular polarization (i.e., right hand sense RHCP and left hand sense LHCP).

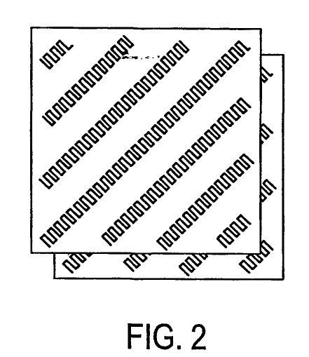

FIG. 2 shows a front view of the meander line polarizer layers 6, 7 according to the preferred embodiment of the present invention. The meander line conductive strip arrays 9, 11 are distributed homogeneously on respective thin dielectric substrates 10, 12. The two meander line layers 6, 7 are separated by the low loss foam layer (e.g., 8), as shown in FIG. 1. FIG. 2 further illustrates that the meander line conductive strip arrays 9, 11 on each of the respective meander line layers 6, 7 are printed at a 45° angle with respect to the polarization direction of the linearly polarized wave.

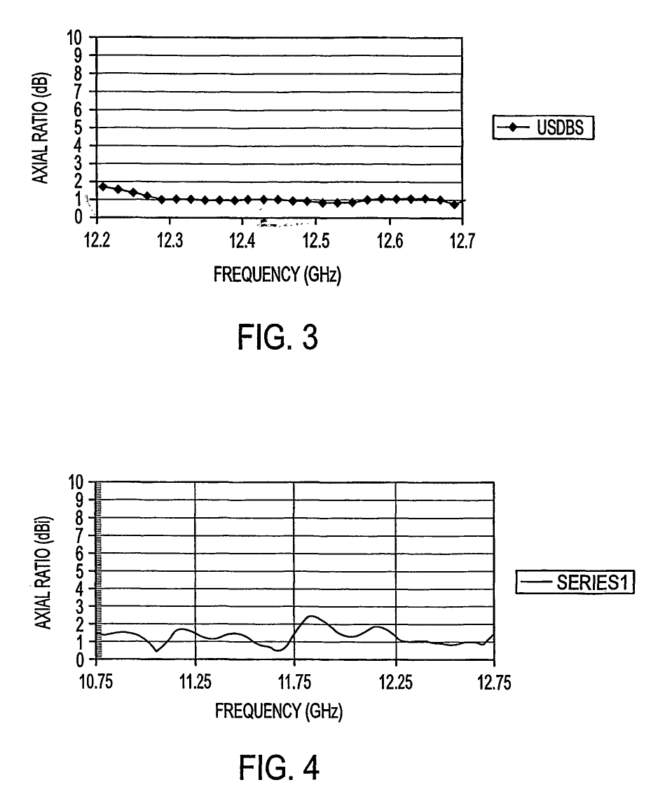

FIG. 3 illustrates the measurement results of the axial ratio over the approximately 500 MHz bandwidth for the meander line polarizer. In FIG. 3, the maximum value is about 1 dB. Further, FIG. 4 illustrates the measured value of the axial ratio for approximately 2 GHz bandwidth, a maximum of which is about 2 dB.

In addition to the foregoing illustrative description, the following additional description is provided. The two meander line polarizer layers may also be separated by a distance that is less than one quarter wavelength. For example, but not by way of limitation, the distance is 0.15 of a wavelength. As noted above, the meander line polarizer layers introduce phase shifts and signal decomposition, which leads to decomposing the signals into two sets of orthogonal linear polarizations at phase quadratures to produce circular polarizations.

Each array has a plurality of parallel conductive strips, and each strip is formed with a periodic and substantially square wave pattern that follows a longitudinal axis. The meander line strip arrays 9, 11 are distributed homogeneously on a major surface of their respective thin dielectric substrates 10, 12, which are made of Mylar in an exemplary embodiment.

The structure of each meander-line strip array 9, 11 is designed to be predominantly inductive to one linear polarization and predominantly capacitive to the orthogonal linear polarization. Accurate spacing between two meander-line layers or sheets 6, 7 can be achieved by using low loss polyfoam as the dielectric 8 (i.e., the foam layer) at a desired thickness. The structure of the polarizer can convert linear to circular polarization according to the following principle. The incident linearly polarized wave can be resolved into two equal linearly polarized components at ±45° relative to the incident wave. The meander lines on each of the respective polarizer layers are oriented at 45° relative to the incident wave. The two orthogonal components are in-phase when incident on the polarizer. On passing through the polarizer, one component goes through an inductive phase change, while the orthogonal component goes through a capacitive phase change. If a phase shift of 90° is achieved by the two wave components when they pass through the polarizer, a circularly polarized wave is generated.

A first width of the conductive material in the meander-line array is a width of the conductor in the longitudinal direction of the metalized line on the plane of the layers 6, 7, while a second width is the dimension of the conductor in a direction orthogonal to the longitudinal direction. The height of the meander-line, which is the spacing between the apicies of the periodic square wave, is measured in the plane of the meander line layer 6, 7, while the period of the meander line is identified as A. The first and second width parameters and the height B determine the operating frequency and the bandwidth of the polarizer. The distance between each meander-line 2, 3 in each respective array 6, 7 determines the phase shift of each layer. For circuit matching purposes, layer 6 and layer 7 have different parameter values, but are not limited thereto. While a square wave pattern is preferred, modifications to such periodic pattern may be utilized, as would be known to one skilled in the art.

The present invention has various advantages over the related art. For example, but not by way of limitation, it is an advantage of the present invention that the number of layers in the printed circuit antenna is reduced from the related art requirement of at least 3 layers to 2 layers, which translates into a reduction of cost.

It will be apparent to those skilled in the art that various modifications and variations can be made to the described illustrative embodiments of the present invention without departing from the spirit or scope of the invention. Thus, it is intended that the present invention cover all modifications and variations of this invention consistent with the scope of the appended claims and their equivalents.

1. An apparatus for performing dual circular polarization in a flat plate antenna, comprising:
a linear polarization structure configured to perform a first sense and a second sense of a linear polarization, and generate linear polarization outputs;
a meander line polarizer positioned on said linear polarization structure and having a first layer stacked on a second layer, wherein said meander line polarizer generates circular polarization signals based on said linear polarization outputs.

2. The apparatus of claim 1, said linear polarization structure comprising:
a first linear polarization layer configured to perform said first sense of said linear polarization; and
a second linear polarization layer, positioned on said first linear polarization layer, and configured to perform said second sense of said linear polarization.

3. The apparatus of claim 2, further comprising at least one foam layer positioned between each of said first linear polarization layer, said second linear polarization layer and said first layer and said second layer of said meander line polarizer.

4. The apparatus of claim 2, wherein each of said first linear polarization layer and said second linear polarization layer comprises:
a polarization power divider; and
a radiation panel positioned on said polarization power divider.

5. The apparatus of claim 4, further comprising said at least one foam layer positioned between said polarization power divider and said radiation panel of each of said first linear polarization layer and said second linear polarization layer.

6. The apparatus of claim 1, further comprising a ground plane positioned on a surface of said linear polarization structure and opposite said meander line polarizer.

7. The apparatus of claim 1, wherein said first sense comprises a left hand circular polarization component, and said second sense comprises a right hand circular polarization component.

8. The apparatus of claim 1, said first layer and said second layer of said meander line polarizer each comprising at least one meander line constructive strip array positioned on a thin dielectric at a 45 degree angle to a direction of said linear polarization.

9. The apparatus of claim 1, wherein an axial ratio of said apparatus at a bandwidth greater than 500 MHz is 1 dB.

10. The apparatus of claim 1, wherein an axial ratio of said apparatus at a bandwidth greater than 2 GHz is 2 dB.

11. A flat plate antenna configured to perform dual circular polarization, comprising:
an apparatus for performing dual circular polarization, including,
a first linear polarization layer configured to perform a first sense of a linear polarization;
a second linear polarization layer, positioned on said first linear polarization layer, configured to perform a second sense of said linear polarization;
a first meander line polarizer layer positioned on said second linear polarization layer, and
a second meander line polarizer layer positioned on said first meander line polarizer layer, wherein said first meander line polarizer layer and said second meander line polarizer layer convert linear polarization signals output from said first linear polarization layer and said second linear polarization layer into circular polarization signals.

12. A method of performing dual circular polarization, comprising the steps of:
(a) performing a first sense of linear polarization to generate a first linearized output;
(b) performing a second sense of linear polarization to generate a second linearized output; and
(c) receiving said first linearized output and said second linearized output in a two-layer meander line polarizer to generate circular polarization signals.

13. The method of claim 12, said (a) comprising:
performing said first sense of said linear polarization in a first linear polarization layer; and
performing said second sense of said linear polarization in a second linear polarization layer that is positioned on said first linear polarization layer.

14. The method of claim 13, wherein at least one foam layer is positioned between each of said first linear polarization layer, said second linear polarization layer and said first layer and said second layer of said meander line polarizer.

15. The method of claim 12, wherein a ground plane is positioned on a surface of said linear polarizer and opposite said meander line polarizer.

16. The method of claim 12, wherein said (a) comprises generating a left hand circular polarization component, and said (b) comprises generating a right hand circular polarization component.

17. The method of claim 12, wherein said first layer and said second layer of said meander line polarizer each comprise at least one meander line constructive strip array positioned on a thin dielectric at a 45 degree angle to a direction of said linear polarization.

18. The method of claim 12, wherein an axial ratio of said apparatus at a bandwidth greater than 500 MHz is 1 dB.

19. The method of claim 12, wherein an axial ratio of said apparatus at a bandwidth greater than 2 GHz is 2 dB.
